(19) United States
(12) Patent Application Publication
(10) Pub. No.: US 2026/0336642 A1
(43) Pub. Date: Oct. 29, 2026

(54) Method and Device for Operating an Automated Motor Vehicle

(71) Applicant: Bayerische Motoren Werke Aktiengesellschaft, Muenchen (DE)

(72) Inventor: David BOYMANNS, Dachau (DE)

(21) Appl. No.: 19/103,597

(22) PCT Filed: Jul. 24, 2023
(86) PCT No.: PCT/EP2023/070463

§ 371 Date: Feb. 13, 2025

(30) Foreign Application Priority Data
Aug. 18, 2022 (DE) 10 2022 120 886.9

(51) Int. Cl. B60W 50/029; B60W 30/12; G05D 1/85

(52) U.S. Cl. CPC B60W 50/029; G05D 1/85; B60W 30/12; B60W 2050/0292; B60W 2720/106; B60W 2754/30

(57) ABSTRACT

A method for operating an automated motor vehicle, wherein the method includes identifying the presence of a malfunction in a drive-by-wire system of the automated motor vehicle and taking over transverse and/or longitudinal guidance of the automated motor vehicle by way of a driver assistance system when a predetermined activation condition for the driver assistance system is met.

### BACKGROUND AND SUMMARY

The present disclosure relates to a method for operating an automated motor vehicle and a data processing device designed to at least partially carry out the method. Furthermore, an automated motor vehicle having the data processing device is provided. Additionally or alternatively, a computer program is provided comprising commands which, upon the execution of the program by a computer, prompt it to at least partially carry out the method. Additionally or alternatively, a computer-readable medium is provided comprising commands which, upon the execution of the commands by a computer, prompt it to at least partially carry out the method.

Recognizing or establishing a presence of a malfunction of a steering system of a motor vehicle is described in DE 10 2020 206 879 A1. DE 10 2020 206 879 A1 relates to a stowable steering column for a motor vehicle, comprising a handlebar adjustable between a retracted position and an extended position, a sensor unit for measuring the adjustment position of the handlebar, and an electronic control unit, wherein the sensor unit is configured to recognize a fault in the adjustment movement of the handlebar and to transmit at least one corresponding error message to the control unit if a fault is recognized.

Furthermore, so-called drive-by-wire systems are known from the prior art. Drive-by-wire (abbreviated DbW) is the designation for (at least partially) driving or controlling vehicles without mechanical force transmission of the operating elements to the corresponding positioning elements, such as throttle valves. The drive-by-wire concept comprises at least one or more of the “X-by-wire” systems here, such as brake-by-wire (brake control), shift-by-wire systems (transmission control), and steer-by-wire (steering).

In accordance with the name, there are no mechanical connections from operating element to controlled positioning element in drive-by-wire systems. The control of functions takes place via electrical lines and servomotors or electromechanical actuators. It can result in a lower fuel consumption if no energy-intensive hydraulic or mechanical systems have to be operated.

The more recent development in automobile construction has had a tendency toward forwarding as many driver commands as possible exclusively electrically. However, a malfunction, such as a failure of the electrical supply, can be challenging in these systems, which could possibly result in an inability to steer or a brake failure.

Against the background of this prior art, the object of the present disclosure is to specify a device and a method which are each capable of elevating the prior art.

The object is achieved by the features of the independent claim. The dependent claims have preferred refinements of the invention as the content.

Accordingly, the object is achieved by a method for operating an automated motor vehicle.

The method can be a computer-implemented method, i.e., one, multiple, or all steps of the method can be at least partially carried out by a computer or a data processing device.

The method comprises establishing a presence of a malfunction of a drive-by-wire system of the automated motor vehicle.

A malfunction can be understood as a deviation of an action actually carried out by the drive-by-wire system, i.e., the actual state, from the state specified by a user of the drive-by-wire system, thus the target state, wherein the deviation goes beyond a regulation-related or control-related deviation. The malfunction can occur in the sensing of a driver input and/or forwarding this input to the respective actuator.

The method furthermore comprises an (automatic) takeover of a lateral and/or longitudinal guidance of the automated motor vehicle by a driver assistance system when a predetermined activation condition of the driver assistance system is met.

In other words, when a malfunction is established in the input devices or the processing of a drive-by-wire system of the automated motor vehicle, the motor vehicle takes over the lateral and/or longitudinal guidance in an automated manner, so that the malfunction of the drive-by-wire system can be compensated for or bypassed.

Possible refinements of the above-described method are explained in detail hereinafter.

The method can comprise checking whether the predetermined activation condition of the driver assistance system or the assistance system is met.

An ODD (operational design domain) of the driver assistance system can be used for this purpose, for example. The ODD is a description of the specific operating conditions under which the automated driving system or driver assistance system is supposed to function properly, including, but not restricted to road types, speed range, environmental conditions (weather, time of day/night, etc.), applicable traffic laws and regulations, and other regional restrictions.

The takeover of the longitudinal guidance of the automated motor vehicle can comprise deceleration of the automated motor vehicle. It is conceivable here that initially the current speed is still maintained or is adapted in an automated manner depending on the functional design so that a distance to the vehicle in front is maintained. This can take place until, for example, a safe stopping option is recognized by the system (such as a freeway parking area).

The deceleration of the automated motor vehicle can take place until the automated motor vehicle is at a standstill.

That is to say, the takeover of the longitudinal guidance can comprise an active intervention in the longitudinal guidance of the motor vehicle.

The takeover of the lateral guidance of the automated motor vehicle can comprise keeping the lane and/or steering the motor vehicle to a roadside, for example, to an emergency stopping lane. Similarly to the longitudinal guidance, the lateral guidance can be used in the short term for stopping the motor vehicle or in the longer term for keeping it in the lane and possibly subsequently steering it to the roadside, for example.

That is to say, the takeover of the lateral guidance can, analogously to the takeover of the longitudinal guidance, comprise an active intervention in the lateral guidance of the motor vehicle.

The drive-by-wire system can comprise a steer-by-wire system and/or a brake-by-wire system.

Steer-by-wire (literally: steering via wire) can be understood as a system in which a steering command is forwarded from a sensor (e.g., the steering wheel) via one or more control units exclusively electrically to the electromechanical actuator which carries out the steering command. No mechanical connection exists between steering wheel and steered wheels in such a system.

Brake-by-wire (literally: brake via wire) describes a brake system in which the actuating and positioning devices are mechanically decoupled from one another. In the conventional hydraulic brake system, the actuating device is the brake pedal and the transmission and positioning device is the hydraulic system. A distinction is made in this case between electrohydraulic brakes, electro pneumatic brakes (in trucks), and electromechanical brakes. In brake-by-wire systems, the coupling between actuating device and brake is exclusively produced by a signal transmission.

The description above can be summarized as follows in other words and with respect to a specific embodiment, which is described hereinafter as not restricted for the disclosure: Vehicles are increasingly being equipped with systems for automating driving tasks (driver assistance systems, SAE L2, L3, and L4 automated driving functions). Furthermore by-wire systems are occupying a larger and larger part in driver operating elements, beginning with accelerator pedals, but also brakes and steering. These new systems can, on the one hand, fail, however, on the other hand, these failures can also be compensated for. In particular the by-wire systems as operating elements for the driver can fail. For example, the steer-by-wire systems first comprise the steering actuators in order to steer or move the wheels, but also the sensing of the steering movement, which is specified by the driver (and possibly a haptics specification). Upon failure of this sensing unit, there is possibly no longer a possibility by means of the steer-by-wire system to control the vehicle in the transverse direction. The same applies, mutatis mutandis, for a brake by-wire system, in which this could occur with the brake pedal. It is therefore proposed that in the event of failure, for example, of the steering wheel angle sensing or brake pedal setting, an automated vehicle in case of fault automatically takes over the control when the vehicle is located in an environment (ODD), in which the respective required automated driving function can be used. It is conceivable that the automated driving function brings the vehicle into a safe standstill, for example, on the emergency breakdown lane. Additionally or alternatively, vehicles which are only equipped with an assistance function can automatically activate this function. Although it is not actually intended for this purpose, this function is supposed to mean a significantly lower risk for the driver, however, than no longer having any control at all over the vehicle. The following situation is conceivable here, for example: The vehicle is equipped with a freeway pilot, i.e., when this function is active the driver can turn to other tasks and does not actively have to take over the driving task (dynamic driving task, DDT). Furthermore, the vehicle is equipped with a steer-by-wire system. If a fault in the steering angle sensor system occurs on the freeway and this is recognized, the freeway pilot function can be automatically activated without input of the driver so that the vehicle does not drive further in an uncontrolled manner.

Furthermore, a computer program is provided, comprising commands which, upon execution of the program by a computer, prompt it to at least partially execute or carry out the above-described method.

A program code of the computer program can be provided in any code, in a code which is suitable for controllers of motor vehicles.

The description above with respect to the method also applies analogously to the computer program and vice versa.

Furthermore, a data processing device, such as a control unit, for an automated motor vehicle is provided, wherein the data processing device or the control unit is configured to at least partially execute or carry out the above-described method.

The data processing device can be part of a driver assistance system or can represent it. The data processing device can be, for example, an electronic control unit (ECU). The electronic control unit can be an intelligent processor-controlled unit which can communicate with other modules, for example, via a central gateway (CGW) and which can optionally form the vehicle onboard network via field buses, such as the CAN bus, LIN bus, MOST bus, and FlexRay or via automotive ethernet, for example, together with telematics control units. It is conceivable that the control unit controls functions relevant for the driving behavior of the motor vehicle, such as the engine control, the force transmission, the braking system, and/or the tire pressure monitoring system. Driver assistance systems, for example, a parking assistant, adaptive cruise control (ACC), a lane departure warning system, a lane change assistant, traffic sign recognition, traffic light signal recognition, a start assistant, a night vision assistant and/or an intersection assistant, can moreover be controlled by the control unit.

The description above with respect to the method and to the computer program also applies analogously to the data processing device and vice versa.

Furthermore, an automated motor vehicle comprising the above-described data processing device is provided.

The motor vehicle can be a passenger vehicle, in particular an automobile, or a utility vehicle such as a truck.

The motor vehicle can be designed to at least partially and/or at least temporarily take over a longitudinal guidance and/or a lateral guidance during automated driving of the motor vehicle.

The automated driving can take place so that the forward movement of the motor vehicle takes place (largely) autonomously. Automated driving can be at least partially and/or temporarily controlled by the data processing device.

The motor vehicle can be a motor vehicle of autonomy level 1, i.e., can have specific driver assistance systems which assist the driver in the vehicle operation, such as the adaptive cruise control (ACC).

The motor vehicle can be a motor vehicle of autonomy level 2, i.e., partially automated so that functions such as automatic parking, lane keeping or lateral guidance, general longitudinal guidance, acceleration, and/or deceleration are taken over by the driver assistance system.

The motor vehicle can be a motor vehicle of autonomy level 3, i.e., conditionally automated so that the driver does not have to continuously monitor the system of the vehicle. The motor vehicle independently carries out functions such as triggering the turn signal, lane changing, and/or lane keeping. The driver can address other things but will be prompted by the system if needed within a prewarning time to take over the control.

The motor vehicle can be a motor vehicle of autonomy level 4, i.e., so highly automated that the guidance of the vehicle is permanently taken over by the system of the vehicle. If the driving tasks are no longer managed by the system, the driver can be prompted to take over the guidance.

The motor vehicle can be a motor vehicle of autonomy level 5, i.e., so fully automated that the driver is not necessary to fulfill the driving task. Except for defining the destination and starting the system, no human intervention is necessary.

The description above with reference to the method, the data processing device, and the computer program also applies analogously to the motor vehicle and vice versa.

Furthermore, a non-transitory computer-readable medium is provided, in particular a computer-readable storage medium. The computer-readable medium comprises commands which, upon the execution of the program by a computer, prompt it to at least partially execute the above-described method.

A computer-readable medium can be provided which comprises an above-described computer program. The computer-readable medium can be any digital data storage device, such as a USB stick, a hard drive, a CD-ROM, an SD card, or an SSD card.

The computer program does not necessarily have to be stored on such a computer-readable storage medium in order to be provided to the motor vehicle, but rather can also be externally acquired via the Internet or in another way.

The description above with reference to the method, the data processing device, the computer program, and the automated motor vehicle also applies analogously to the computer-readable medium and vice versa.

An embodiment is described hereinafter with reference to FIGS. 1 and 2.

### BRIEF DESCRIPTION OF THE DRAWINGS

FIG. 1 schematically shows an automated motor vehicle designed to execute or carry out a method according to the disclosure for operating the automated motor vehicle, and

FIG. 2 schematically shows a flow chart of the method.

### DETAILED DESCRIPTION OF THE DRAWINGS

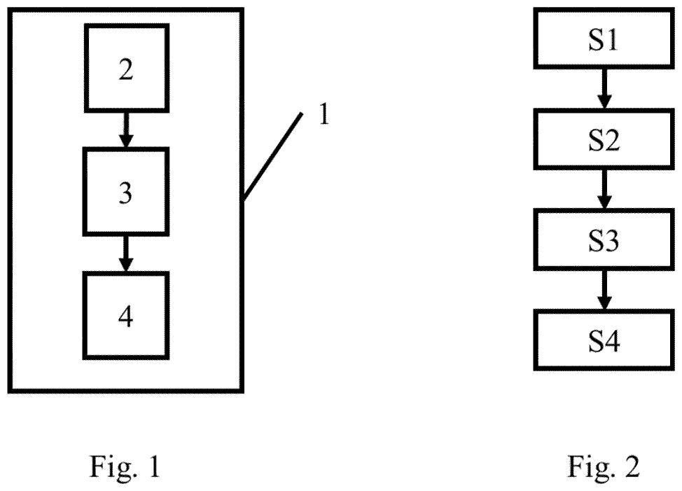

The automated motor vehicle 1 shown in FIG. 1 comprises a drive-by-wire system 2 (for example, a steer-by-wire system and/or a brake-by-wire system), a control unit 3, and a driver assistance system 4.

The motor vehicle 1 is designed, using the above-described units 2-4, to execute the method for operating the automated motor vehicle 1, the flow chart of which is shown in FIG. 2.

As shown in FIG. 2, the method essentially has four steps S1-S4.

In a first step S1 of the method, a presence of a malfunction of the drive-by-wire system 2 is established by means of the control unit 3.

In a second step S2 of the method, it is checked by means of the control unit 2 whether the predetermined activation condition of the driver assistance system 4 is met.

In a third step S3 of the method, a control signal, here an activation signal, is output from the control unit 3 to the driver assistance system 4 if the check in the second step S2 has the result that the predetermined activation condition of the driver assistance system 4 is met.

In a fourth step S4 of the method, a lateral guidance and a longitudinal guidance of the automated motor vehicle 1 are taken over by means of the driver assistance system 4 activated by the control signal output in the third step S3.

The takeover of the longitudinal guidance of the automated motor vehicle can comprise deceleration of the automated motor vehicle 1 and steering of the automated motor vehicle 12 at a roadside. This can take place, for example, until the automated motor vehicle 1 is at a standstill on a shoulder.

### LIST OF REFERENCE SIGNS

1 motor vehicle
2 drive-by-wire system
3 control unit
4 driver assistance system
S1-S4 method steps

1.-10. (canceled)

11. A method for operating an automated motor vehicle, the method comprising:
establishing a presence of a malfunction of a drive-by-wire system of the automated motor vehicle; and
taking over of a lateral guidance and/or a longitudinal guidance of the automated motor vehicle by a driver assistance system based on a predetermined activation condition of the driver assistance system being met.

12. The method according to claim 11, wherein the method comprises a check as to whether the predetermined activation condition of the driver assistance system is met.

13. The method according to claim 11, wherein a takeover of the longitudinal guidance of the automated motor vehicle comprises decelerating and/or maintaining a distance to a vehicle in front of the automated motor vehicle.

14. The method according to claim 12, wherein a takeover of the longitudinal guidance of the automated motor vehicle comprises decelerating and/or maintaining a distance to a vehicle in front of the automated motor vehicle.

15. The method according to claim 13, wherein a deceleration of the automated motor vehicle takes place until the automated motor vehicle is at a standstill.

16. The method according to claim 14, wherein a deceleration of the automated motor vehicle takes place until the automated motor vehicle is at a standstill.

17. The method according to claim 11, wherein a takeover of the lateral guidance of the automated motor vehicle comprises lane keeping and/or steering the motor vehicle to a roadside and/or onto a parking area.

18. The method according to claim 12, wherein a takeover of the lateral guidance of the automated motor vehicle comprises lane keeping and/or steering the motor vehicle to a roadside and/or onto a parking area.

19. The method according to claim 11, wherein the drive-by-wire system comprises a steer-by-wire system and/or a brake-by-wire system.

20. The method according to claim 12, wherein the drive-by-wire system comprises a steer-by-wire system and/or a brake-by-wire system.

21. A non-transitory computer-readable medium storing a program comprising commands which, upon execution of the program by a computer, cause the computer to carry out a method according to claim 11.

22. A non-transitory computer-readable medium storing a program comprising commands which, upon execution of the program by a computer, cause the computer to carry out a method according to claim 12.

23. A non-transitory computer-readable medium storing a program comprising commands which, upon execution of the program by a computer, cause the computer to carry out a method according to claim 13.

24. A data processing device for a motor vehicle, wherein the data processing device is configured to carry out a method according to claim 11.

25. A data processing device for a motor vehicle, wherein the data processing device is configured to carry out a method according to claim 12.

26. A data processing device for a motor vehicle, wherein the data processing device is configured to carry out a method according to claim 13.

27. An automated motor vehicle, comprising the data processing device according to claim 24.
